(19) United States
(12) Patent Application Publication
(10) Pub. No.: US 2026/0221063 A1
(43) Pub. Date: Jul. 30, 2026

(54) SYSTEM AND METHOD FOR MICROLED DISPLAY WITH REDUNDANT LEDS

(71) Applicant: SCT LTD., Grand Cayman (KY)

(72) Inventors: Eric LI, Milpitas, CA (US); Yi ZHANG, Milpitas, CA (US); Shang-Kuan TANG, Milpitas, CA (US)

(21) Appl. No.: 19/458,994

(22) Filed: Jan. 26, 2026

Related U.S. Application Data
(60) Provisional application No. 63/750,496, filed on Jan. 28, 2025.

(51) Int. Cl. G09G 3/00; G09G 3/32

(52) U.S. Cl. CPC G09G 3/006; G09G 3/32; G09G 2320/0233; G09G 2320/0247; G09G 2320/064; G09G 2330/08; G09G 2330/10; G09G 2330/12

(57) ABSTRACT

An LED display system with an LED array with redundant LEDs configured to supplement malfunctioned LEDs, includes: the LED array includes m rows and n columns of pixels, each pixel further includes x LEDs and y redundant LEDs; an analog driver with m scan switches, each scan switch is connected to the common cathode of a corresponding row of n pixels, an anode of each of the x LEDs and the y redundant LEDs of each pixel receives current from a current source on the analog driver, all LEDs connected to the same current source form a channel, (x+y)*n channels are formed; a power supply with a voltage of VCC; a digital controller for processing input signals and outputs control signals to the analog driver; and a failure detection circuit for monitoring a status of each of the x number of LEDs of each pixel.

### FIELD OF TECHNOLOGY

The present disclosure relates to system and method for microLED display, and in particular to system and method for microLED display with redundant LEDs.

### BACKGROUND

A microLED (µLED) display system has an LED array arranged in the planar direction. Pixels in the LED array may be single color µLEDs or multiple color µLEDs (e.g., RGB LEDs). Each pixel is connected to a driver circuit while the driver circuit is connected to a controller circuit. The controller circuit receives, processes, and send image data to the driver circuit, which drives the pixel to turn on or off at the prescribed moment for a prescribed duration. When proper on-off or greyscale signals are provided, the array can display images. The images can be viewed by naked eyes directly. Alternatively, the images can be projected by an optical system to a reflective plane for reviewing.

The architecture of a µLED display system is designed for high precision and reliability. The planar arrangement of the LED array allows for a compact and scalable configuration, making it suitable for both small and large displays. Each pixel, whether single color or multi-color, is individually addressable through its dedicated driver circuit. This enables fine control over brightness, color mixing, and refresh rates, which are essential for delivering high-resolution and vivid images. The use of RGB µLEDs in particular allows for full color reproduction, making the display capable of showing true-to-life visuals with a wide color gamut.

To ensure consistent image quality and long-term performance, the system incorporates redundancy at the pixel level. Redundant µLEDs are included within each pixel, so if a primary µLED fails, a spare can be activated seamlessly. This approach mitigates the risk of visible defects in the display caused by broken or non-responsive µLEDs. For the entirety of this disclosure, broken is synonymous with malfunctioned. The failure detection circuit continuously monitors the status of each µLED, and the controller circuit automatically switches control signals from the faulty LED to the redundant one. As a result, the display maintains full functionality and visual integrity even in the event of individual component failures.

In addition to direct viewing, the µLED display can be integrated with optical systems for projection applications. By directing the emitted light onto a projection screen, the system can produce larger images suitable for presentations. The light can also be directed to a waveguide and form images on the retina where no screen is needed. The ability to project images expands the versatility of µLED technology, allowing it to be used in various settings such as digital signage, advanced display walls and , augmented reality (“AR”) and virtual reality(“VR”).

Overall, the combination of advanced driver and controller circuits, redundancy strategies, and flexible display configurations makes µLED systems highly adaptable and robust. These features support a wide range of applications, from consumer electronics to industrial and commercial displays, providing reliable performance and exceptional image quality.

One of the drawbacks of µLED display is that broken µLEDs are difficult to replace, especially small pitch µLED. Broken µLEDs stay dark and do not respond to different driving signals. When broken µLEDs become visible, the µLED display may no longer be in a working order.

This disclosure provides a solution to mitigate the effect of broken µLEDs by having redundant or spare µLEDs in the display. The µLED array is provided a number of extra µLEDs that are normally not in operation. Once one of the working µLEDs fails due to an open circuit or a shorted circuit, the system detects the failure, turns off power and driving signals to the broken µLED and turns on the power and the driving signals to one of the spare µLED. As such, the display remains in good working condition. In this disclosure, both LED and µLED are implemented. The present disclosure herein can be implemented for both LED and µLED. In this disclosure, “LED” generally encompasses “µLED” but sometimes they are used interchangeably as can be determined based on the context.

The number of spare µLEDs can vary. One way to define the redundancy is by the number of spare µLEDs to the total number of µLEDs in an LED arrays. For example, there could be one spare LED in every two, three, four or more LEDs. When there is one spare LED in every two LEDs, there is one spare LED for each working LED. The redundancy ratio is 1:1 or 100%. When there is one spare in every three LEDs (i.e., for every two working LEDs), the redundancy ratio is 1:2 or 50%. When there is one spare in every four LEDs (i.e., for every three working LEDs), the redundancy ratio is 1:3 or 33%.

### SUMMARY

According to an embodiment of the disclosure, an LED display system with an LED array with redundant LEDs configured to supplement malfunctioned LEDs is disclosed. The LED display system includes: the LED array, the LED array comprises m rows and n columns of pixels, wherein each pixel further comprises x number of LEDs and y number of redundant LEDs, the x number of LEDs and the y number of redundant LEDs of each pixel are connected in a common cathode configuration; an analog driver with m scan switches, each scan switch is connected to the common cathode of a corresponding row of n pixels, an anode of each of the x number of LEDs and the y number of redundant LEDs of each pixel receives current from a current source on the analog driver, all LEDs connected to the same current source form a channel, (x+y)*n number of channels are formed; a power supply with a voltage of VCC; a digital controller for processing input signals and outputs control signals to the analog driver; and a failure detection circuit for monitoring a status of each of the x number of LEDs of each pixel, and for feeding information of broken LEDs to the digital controller, wherein the failure detection circuit further includes: an LED open comparator for detecting a malfunctioned LED due to an open circuit; an open latch; an LED short comparator for detecting a broken LED due to a short circuit; and a short latch.

According to an embodiment of the disclosure, for each channel, wherein a voltage input of the LED open comparator and a voltage input of the LED short comparator are connected to the anode of a corresponding channel. According to an embodiment of the disclosure, the LED open comparator of the failure detection circuit of the corresponding channel has a reference voltage of V_threshold_open. According to an embodiment of the disclosure, an output signal from the LED open comparator and an output from the LED short comparator are inputted into the open latch and the short latch respectively. According to an embodiment of the disclosure, if V_anode is lower than V_threshold_short, the LED is considered shorted. According to an embodiment of the disclosure, if V_anode is larger than V_threshold_open , the LED is considered open. According to an embodiment of the disclosure, an output of the open latch and an output of the short latch are transmitted into the digital controller for PWM signal generation. According to an embodiment of the disclosure, a PWM signal to a shorted LED is switched off. According to an embodiment of the disclosure, a PWM signal to an open LED is switched off. According to an embodiment of the disclosure, a PWM signal to a redundant LED in the same pixel of the shorted LED is switched on. According to an embodiment of the disclosure, a PWM signal to a redundant LED in the same pixel of the open LED is switched on.

According to an embodiment of the disclosure, a method for supplementing malfunctioned LEDs with redundant LEDs in an LED display system is disclosed. The method includes: deploying the LED display system with an LED array with redundant LEDs configured to supplement malfunctioned LEDs, wherein the LED display system includes: the LED array, the LED array comprises m rows and n columns of pixels, each pixel further comprises x number of LEDs and y number of redundant LEDs, the x number of LEDs and the y number of redundant LEDs of each pixel are connected in a common cathode configuration; an analog driver with m scan switches, each scan switch is connected to the common cathode of a corresponding row of n pixels, an anode of each of the x number of LEDs and the y number of redundant LEDs of each pixel receives current from a current source on the analog driver, all LEDs connected to the same current source form a channel, (x+y)*n number of channels are formed; a power supply with a voltage of VCC; a digital controller for processing input signals and outputs control signals to the analog driver; and a failure detection circuit for monitoring a status of each of the x number of LEDs of each pixel, and for feeding information of broken LEDs to the digital controller, the failure detection circuit further includes: an LED open comparator for a malfunctioned LED due to an open circuit; an open latch; an LED short comparator for detecting a broken LED due to a short circuit; and a short latch.

According to an embodiment of the disclosure, the anode of each channel is connected to the LED open comparator and the LED short comparator, the failure detection circuit is working in scanning mode, with n*(x+y)*2 comparators. According to an embodiment of the disclosure, the LED open comparator of the failure detection circuit of the corresponding channel has a reference voltage of V_threshold_open, the LED open comparator compares the V_anode with V_threshold_open, the LED short comparator has reference voltage of V_threshold_short, the LED short comparator compares the V_anode with V_threshold_short. According to an embodiment of the disclosure, an output signal from the LED open comparator and an output from the LED short comparator are inputted into the open latch and the short latch respectively. According to an embodiment of the disclosure, if V_anode is lower than V_threshold_short, the LED is considered shorted. According to an embodiment of the disclosure, if V_anode is larger than V_threshold_open, the LED is considered open. According to an embodiment of the disclosure, an output of the open latch and an output of the short latch are transmitted into the digital controller for PWM signal generation. According to an embodiment of the disclosure, a PWM signal to a shorted or open LED is switched off. According to an embodiment of the disclosure, a PWM signal to a redundant LED in the same pixel of the shorted or open LED is switched on.

### BRIEF DESCRIPTION OF THE FIGURES

The disclosure will now be explained in more detail using exemplary embodiments and with references to the drawings, in which:

FIG. 1 is a schematic drawing illustrating a m by n µLED array having one spare µLED in four µLEDs, i.e., a redundancy ratio of 33%, according to an embodiment of the disclosure.

FIG. 2 is a schematic drawing illustrating that PWM signals to a cluster of four µLED having three working µLEDs and one spare µLED at different scenarios of the operation, according to an embodiment of the disclosure.

FIG. 3 is a schematic drawing illustrating an exemplary failure detection circuit of an µLED array, according to an embodiment of the disclosure.

FIG. 4 is a flowchart illustrating a process for detecting broken µLEDs, according to an embodiment of the disclosure.

### DETAILED DESCRIPTION OF PREFERRED EMBODIMENTS

The disclosure is susceptible to many embodiments. Preferred embodiments are illustrated in the attached figures and explained below. Minor variations of the preferred embodiments are evident in the figures, but are substantially the same, with common or similar components and the same reference numbers, except as noted.

Reference will now be made in detail to embodiments of the present disclosure, examples of which are illustrated in the accompanying drawings. It is noted that wherever practicable, similar or like reference numbers may be used in the drawings and may indicate similar or like elements.

The drawings depict embodiments of the present disclosure for purposes of illustration only. One skilled in the art would readily recognize from the following description that alternative embodiments exist without departing from the general principles of the disclosure.

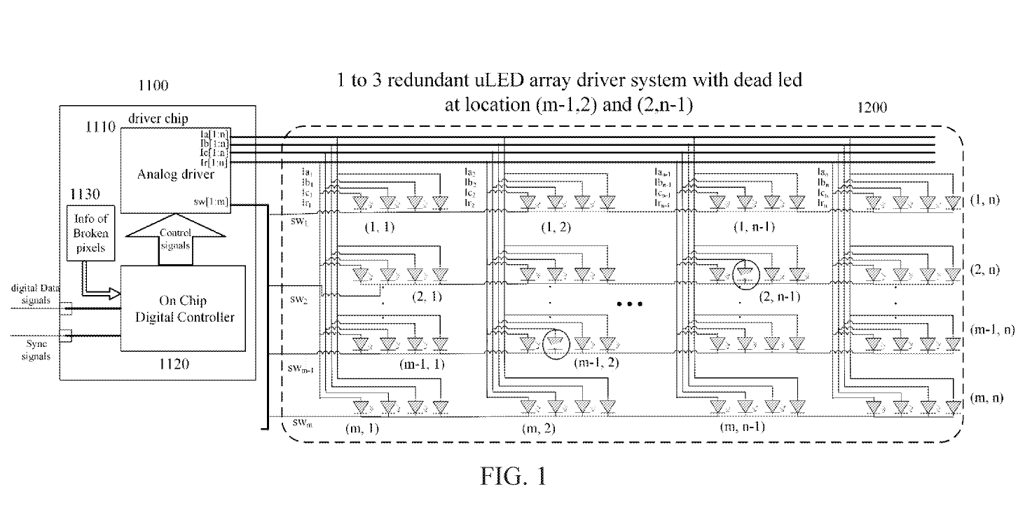

FIG. 1 is a schematic drawing illustrating a m by n µLED array having one spare µLED in four µLEDs, i.e., a redundancy ratio of 33%, according to an embodiment of the disclosure. µLED and LED are used interchangeably throughout this disclosure. The µLED array 1200 has m rows and n columns of pixels, for example, single-color µLEDs connected in a common cathode configuration. The first row of pixels are, for example, (1, 1), (1, 2), …… (1, n), and the m-th row of pixels are (m, 1), (m, 2), …… (m, n-1), (m, n). Each pixel in this example illustrated in FIG. 1 includes three µLEDs and one redundant µLED, i.e., a redundancy ratio of 33% as discussed above. The driver chip 1100 includes an analog driver 1110. Scan switches SW₁ ~ SWₘ are connected to the analog driver 1110 (i.e., analog circuit) on the driver chip 1100 and receives ON-OFF commands therefrom, with SW₁ connected to the first row, SWₘ connected to the m-th row. Anodes of the µLEDs are connected to four current sources in the analog driver. Three of the working µLEDs are configured to receive currents Iₐ, I_{b}, I_{c} while the spare µLED receives Iᵣ. A string of µLEDs having anodes of the µLEDs connected to a current source is a channel. Accordingly, the µLEDs array has 4 x n number of channels. The channels to the first column of pixels are Iₐ₁, I_{b1},I_{c1},Iᵣ₁, and the channels to the second column of pixels are Iₐ₂, I_{b2},I_{c2},Iᵣ₂, , …, and the channels to the nth column of pixels are Iₐₙ, I_{bn}, I_{cn}, Iᵣₙ. Redundant LEDs also form a channel. In the normal case, the current in the channel is zero, no lights go through it. If a broken LED is detected, there will be PWM current signal inside the corresponding channel during the right scan time.

The digital controller 1120 (i.e., digital control circuit) on the driver chip 1100 processes input signals and outputs control signals to the analog driver 1110 as known in the art. The driver chip 1100 also has a failure detection circuit 1130 that monitor the status of µLEDs in the array and feeds the information of broken µLEDs to the digital controller 1120. For example, µLEDs at locations (m-1, 2) and (n, 2-1) in FIG. 1 are broken.

By implementing a redundancy ratio of 33%, the system significantly increases its reliability and operational lifespan. In the event of a failure of any of the three primary µLEDs within a pixel, the spare µLED can be activated to maintain display integrity. This approach minimizes downtime and reduces the need for immediate physical repairs, which is particularly advantageous in large-scale or inaccessible display installations.

The channel configuration, where each channel corresponds to a series of µLEDs supplied by a dedicated current source, enables precise control and monitoring of individual µLEDs. The failure detection circuit plays a critical role by continuously assessing the health of each µLED and promptly signaling the digital controller when a malfunction occurs. This automated detection and supplementation mechanism ensures seamless operation, as the controller can swiftly redirect current from a failed µLED to its designated spare.

Such redundancy strategies are scalable and adaptable. For applications demanding higher reliability, the redundancy ratio can be increased—for example, a 1:1 ratio where every operational µLED has a corresponding spare. The system architecture also allows for flexibility in supporting arrays of different colors, such as RGB configurations, by providing additional power sources for each color channel while maintaining the same fundamental redundancy principle.

Overall, the described µLED array with integrated redundancy and failure detection circuits exemplifies a robust solution for high-performance LED display systems, ensuring consistent image quality and reducing maintenance requirements.

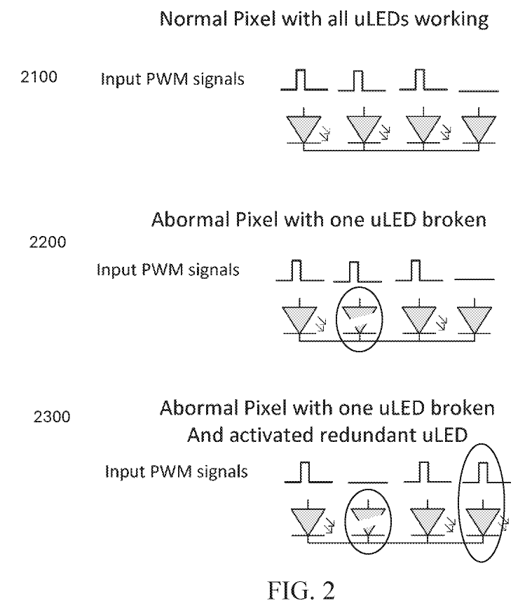

FIG. 2 is a schematic drawing illustrating that PWM signals to a cluster of four µLED having three working µLEDs and one spare µLED at different scenarios of the operation, according to an embodiment of the disclosure. The top panel 2100 shows that all three working µLEDs are functional and each driven by PWM signals output from the digital controller. The middle panel 2200 shows that one of the three normally working µLEDs is broken but still receives PWM. The bottom panels 2300, after detecting of the broken µLED, the driver switches off PMW control signals to it and activates the spare µLED with PWM signal.

This disclosure highlights the dynamic response of the system to LED failures and the role of pulse-width modulation (PWM) in maintaining display performance. In the normal operation scenario (top panel 2100), the digital controller delivers individual PWM signals to each of the three primary µLEDs, ensuring precise brightness control and color rendering. The presence of distinct PWM signals for each working µLED allows for smooth gradation and high image quality across the display.

When a failure occurs, as depicted in the middle panel 2200, one of the µLEDs ceases to function, yet the system initially continues to provide a PWM signal to the failed unit. This transitional state underscores the need for real-time failure detection to prevent wasted energy and potential image artifacts. The system’s failure detection circuit continuously monitors the status of each µLED, promptly identifying any loss of functionality.

Upon detection of a fault (bottom panels 2300), the system demonstrates its redundancy mechanism. The digital controller, informed by the failure detection circuit, immediately disables the PWM output to the faulty µLED, thereby conserving power and avoiding unnecessary signal transmission. Simultaneously, the controller redirects the PWM control to the spare µLED within the cluster, which seamlessly takes over the role of the failed device. This automatic switchover not only preserves the visual integrity of the display but also minimizes downtime and maintenance interventions.

The use of PWM signals for both working and spare µLEDs ensures that the supplementation process does not introduce flicker or brightness inconsistencies, providing a continuous and reliable user experience. This approach is particularly advantageous in large-scale or mission-critical display systems where uninterrupted operation is essential. Overall, FIG. 2 exemplifies how integrated failure detection and redundancy, combined with advanced PWM control, deliver robust performance and enhanced reliability in modern µLED display arrays.

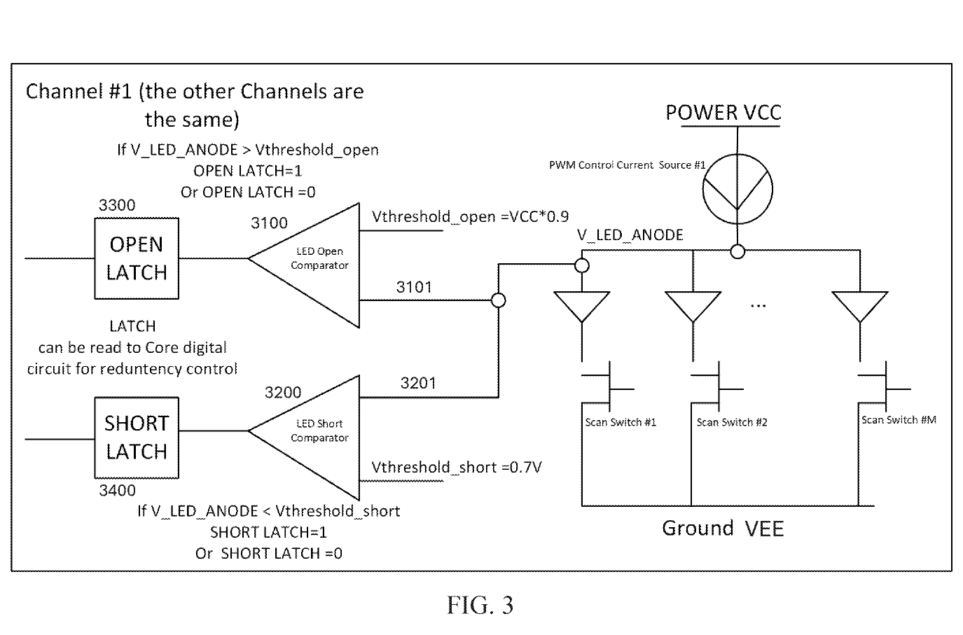

FIG. 3 is a schematic drawing illustrating an exemplary failure detection circuit, according to an embodiment of the disclosure. In high-performance µLED display systems, maintaining operational integrity and image quality is paramount, particularly for large-scale or mission-critical installations. An important aspect of such reliability is the integration of advanced failure detection circuits within the driver architecture. These circuits continuously monitor the electrical health of each µLED, enabling the system to identify and respond to individual device failures in real time. This proactive diagnostic capability underpins the system’s redundancy mechanisms, ensuring that display performance is preserved even in the face of component degradation or unexpected faults.

The circuit has an LED Open Comparator 3100 for detecting an LED that is broken due to an open circuit as well as an LED Short Comparator 3200 for detecting a broken LED having a short circuit. Both comparators 3100 and 3200 have a voltage input, 3101 and 3201 respectively, that connects to the anode of the LED channel. For example, channel#1 is illustrated in FIG. 3. The reference voltage V_threshold_openin the LED Open Comparator 3100 is set at 0.9*VCC, where VCC is voltage of the power supply and is set at a value that is slightly larger than the forward voltage of the LED in the channel. In other words, if the voltage drop between the VCC and the LED anode is less than 0.1*VCC, the LED is considered open and no current is going through the LED. For red LEDs, the VCC may be in the range of 2.4-3.2 V, e.g., 2.8 V. For blue and green LEDs, the VCC may be in the range of 3.2-4.4 V, e.g., 3.8 V.

The reference voltage V_threshold_shortfor the LED Short Comparator 3100 is set at a fixed value, e.g., 0.7V or lower. It means that if the V_anode is lower than the threshold value, the LED is considered shorted.

The threshold values may vary due to the differences in the LEDs as well as operating conditions. The values exemplified above are for illustrative purposes and may be adjusted.

The output signals from the LED Open Comparator 3100 and from the LED Short Comparators 3200 are inputted into an “OPEN LATCH” circuit 3300 and a “SHORT LATCH” circuit 3400, respectively. Outputs from both latch circuits can be read to the digital controller, which controls the PWM signal generation of the broken LED accordingly. Specifically, the controller turns off the PWM current to broken LED while provides PWM current to the spare LED. These latches serve as memory elements, capturing and holding the detection status until the digital controller polls their outputs. This disclosure ensures that transient faults or rapid detection events are reliably registered, enabling the system controller to take corrective action without missing critical fault information.

Upon latching a failure event, the digital controller interfaces with the analog driver to modify the pulse-width modulation (PWM) signals supplied to the affected µLED. Specifically, the controller disables PWM current to the identified faulty device, thereby conserving power and preventing further signal transmission to a non-functional channel. Simultaneously, the controller activates the PWM signal for the designated spare µLED within the same pixel cluster, seamlessly restoring display functionality.

The described failure detection system is tightly coupled with the redundancy architecture of the µLED array. Each pixel cluster typically comprises several primary µLEDs and at least one spare device, connected in a common cathode configuration. When a failure is detected and latched, the system automatically reallocates current and PWM control from the failed µLED to the corresponding spare. This transition is managed by the digital controller, which updates the PWM mapping in real time based on the current health status provided by the detection circuit.

By leveraging this automated detection and switchover process, the display can maintain consistent brightness, color rendering, and image quality without introducing flicker or visible artifacts. The use of individual PWM channels for both working and spare µLEDs ensures that supplementing devices are driven with the same precision as their operational counterparts, upholding the high standards demanded by modern display applications.

The integration of sophisticated failure detection and redundancy strategies yields substantial benefits at the system level. Continuous health monitoring minimizes downtime and reduces the need for immediate manual intervention, which is especially valuable for displays deployed in hard-to-access or mission-critical environments. The architecture is inherently scalable: redundancy ratios can be adjusted (e.g., from 3:1 to 1:1) to meet specific reliability targets, and the approach readily accommodates multi-color µLED arrays (such as RGB configurations) by extending detection and redundancy circuits to each color channel.

Moreover, the modular nature of the comparator and latch circuits allows for straightforward adaptation to different µLED technologies and system voltages, supporting a broad range of display sizes and performance requirements.

The accuracy of failure detection hinges on the proper selection of comparator threshold values. These thresholds must be tuned to the characteristics of the specific µLEDs in use—including their forward voltage, temperature coefficients, and expected aging behavior—as well as the supply voltage environment. Dynamic calibration or adaptive thresholding may be employed in advanced systems to compensate for environmental changes, ensuring robust fault detection over the operational lifetime of the display. Careful design of these parameters is essential to avoid false positives (incorrectly flagging functional devices as failed) or false negatives (missing actual failures).

The failure detection circuit depicted in FIG. 3 exemplifies a robust and technically sophisticated approach to enhancing the reliability of µLED display systems. By combining precise comparator-based monitoring, latch-based event retention, and seamless integration with redundancy and PWM control mechanisms, the architecture delivers continuous, high-quality performance with minimal maintenance overhead. Such systems are well-suited to demanding applications where display consistency and uptime are critical, and their flexible, scalable design ensures longevity and adaptability in the rapidly evolving field of solid-state displays.

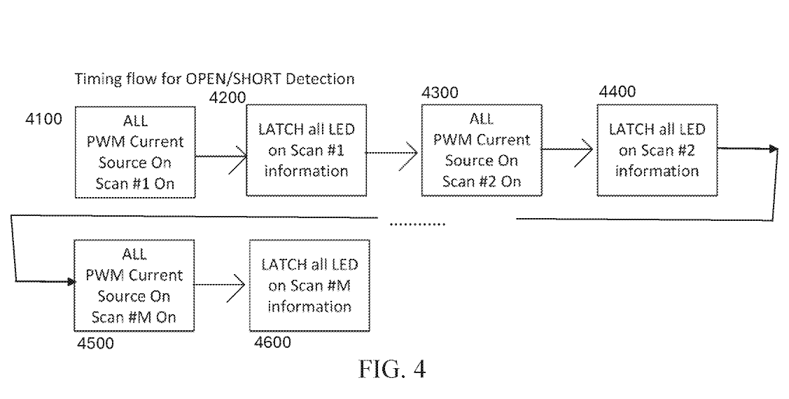

FIG. 4 is a flowchart illustrating a process for detecting broken LEDs, according to an embodiment of the disclosure. Initially, at step 4100, all PWM current sources are on and scan line #1 is on (SW₁ is ON). At step 4200, the detection circuit examines the condition of LEDs in scan line #1 by going through all 4 x n channels. If a broken LED is detected, the controller stores the location of the broken LED and switch off the PWM current source to it during next display cycle. In the meantime, the current signal to the spare LED is switched on. After that scan line #1 is off (SW₁ turned OFF) and scan line #2 is on (SW₂ is ON), the detection circuit examines the conditions of LEDs in scan line #2. The detection circuit works in a scanning mode. It first checks all the LED connected to SCAN 1. After the check is done, it checks all the LED connected to SCAN Line 2. Then Line3, and Line4, etc. The detection procedure will check all the LED and store the error info, which will be used to generate PWM signal inside redundant channel and compensate for any failed LED. These steps are repeated for scan line #2, steps 4300 and 4400, to scan line #M, steps 4500 and 4600, so that all broken LEDs may be detected. Every broken, or malfunctioned, LED detected will be later supplemented with a spare LED, as discussed above.

As it is readily appreciated, when there is one spare for every three LEDs, if two or all three LEDs are broken, only one may be supplemented. Based on the application, the redundancy ratio may be increased to 1:1 so that every working LED has a spare. Even higher ratios may be possible based on the system requirement, e.g., reliabilities.

Further, even though the LED array in FIG. 1 has LEDs of the same color, one may readily an LED array that has two or three types color LEDs, e.g., two or all of RGB LEDs. In that case, additional power sources for GB LEDs are needed but the principle stays the same. Working LEDs are provided with one or more spare LEDs of the same kind that can be activated when a working LED is broken. This sequential scanning and supplementation process allows for systematic coverage of the entire display, supporting robust fault management across large and complex µLED arrays.

When there is one spare for every three LEDs, if two or all three LEDs are broken, only one may be supplemented. This limitation highlights the importance of selecting an appropriate redundancy ratio based on the specific reliability requirements of the application. For environments where display uptime and fault tolerance are paramount—such as in mission-critical signage or medical imaging displays—the redundancy ratio may be increased to 1:1, ensuring that every working LED has a dedicated spare. Even higher ratios may be possible based on system requirements and targeted reliability levels, though these configurations may entail increased design complexity and cost.

Further, even though the LED array in FIG. 1 has LEDs of the same color, one may readily design an LED array that has two or three types of color LEDs, such as RGB or other multi-color configurations. In such cases, additional power sources for the green and blue (GB) LEDs are required, but the underlying principle of redundancy and automated switchover remains unchanged. For multi-color arrays, the system must ensure that each color channel has sufficient spare devices of the same type, guaranteeing seamless color rendering and consistent image quality even in the event of individual LED failures. This disclosure supports a wide range of display applications, from full-color video walls to high-resolution monitors, by enabling dynamic fault recovery and sustaining the visual performance expected in modern solid-state displays.

The integration of the detection and supplementing process with the digital controller and analog driver allows for sophisticated health monitoring and real-time fault management. The use of latches and comparators, as discussed in the surrounding context, ensures that transient faults are reliably captured and that corrective actions are taken swiftly. Additionally, the modular architecture of the detection circuit facilitates adaptation to different LED technologies, color configurations, and redundancy strategies, making the system scalable and future-proof. The process described in FIG. 4 exemplifies a comprehensive solution for maintaining high display reliability, minimizing maintenance requirements, and extending the operational lifetime of µLED-based displays.

What is claimed is:

1. An LED display system with an LED array with redundant LEDs configured to supplement malfunctioned LEDs, the LED display system comprising:
the LED array, wherein the LED array comprises m rows and n columns of pixels, wherein each pixel further comprises x number of LEDs and y number of redundant LEDs, wherein the x number of LEDs and the y number of redundant LEDs of each pixel are connected in a common cathode configuration;
an analog driver with m scan switches, wherein each scan switch is connected to the common cathode of a corresponding row of n pixels, wherein an anode of each of the x number of LEDs and the y number of redundant LEDs of each pixel receives current from a current source on the analog driver, wherein all LEDs connected to the same current source form a channel, wherein (x+y)*n number of channels are formed;
a power supply with a voltage of VCC;
a digital controller for processing input signals and outputs control signals to the analog driver; and
a failure detection circuit for monitoring a status of each of the x number of LEDs of each pixel, and for feeding information of broken LEDs to the digital controller, wherein the failure detection circuit further comprises:
an LED open comparator for detecting a malfunctioned LED due to an open circuit;
an open latch;
an LED short comparator for detecting a broken LED due to a short circuit; and
a short latch.

2. The LED display system of claim 1, for each channel, wherein a voltage input of the LED open comparator and a voltage input of the LED short comparator are connected to the anode of a corresponding channel.

3. The LED display system of claim 2, wherein the LED open comparator of the failure detection circuit of the corresponding channel has a reference voltage of V_threshold_open.

4. The LED display system of claim 2, wherein an output signal from the LED open comparator and an output from the LED short comparator are inputted into the open latch and the short latch respectively.

5. The LED display system of claim 2, if V_anode is lower than V_threshold_short, the LED is considered shorted.

6. The LED display system of claim 2, if V_anode is larger than V_threshold_open , the LED is considered open.

7. The LED display system of claim 2, wherein an output of the open latch and an output of the short latch are transmitted into the digital controller for PWM signal generation.

8. The LED display system of claim 7, wherein a PWM signal to a shorted LED is switched off.

9. The LED display system of claim 7, wherein a PWM signal to an open LED is switched off.

10. The LED display system of claim 7, wherein a PWM signal to a redundant LED in the same pixel of the shorted LED is switched on.

11. The LED display system of claim 7, wherein a PWM signal to a redundant LED in the same pixel of the open LED is switched on.

12. A method for supplementing malfunctioned LEDs with redundant LEDs in an LED display system, the method comprising:
deploying the LED display system with an LED array with redundant LEDs configured to supplement malfunctioned LEDs, wherein the LED display system comprises:
the LED array, wherein the LED array comprises m rows and n columns of pixels, wherein each pixel further comprises x number of LEDs and y number of redundant LEDs, wherein the x number of LEDs and the y number of redundant LEDs of each pixel are connected in a common cathode configuration;
an analog driver with m scan switches, wherein each scan switch is connected to the common cathode of a corresponding row of n pixels, wherein an anode of each of the x number of LEDs and the y number of redundant LEDs of each pixel receives current from a current source on the analog driver, wherein all LEDs connected to the same current source form a channel, wherein (x+y)*n number of channels are formed;
a power supply with a voltage of VCC;
a digital controller for processing input signals and outputs control signals to the analog driver; and
a failure detection circuit for monitoring a status of each of the x number of LEDs of each pixel, and for feeding information of broken LEDs to the digital controller, wherein the failure detection circuit further comprises:
an LED open comparator for detecting a malfunctioned LED due to an open circuit;
an open latch;
an LED short comparator for detecting a broken LED due to a short circuit; and
a short latch.

13. The method of claim 12, wherein the anode of each channel is connected to the LED open comparator and the LED short comparator, wherein the failure detection circuit is working in scanning mode, with n*(x+y)*2 comparators.

14. The method of claim 12, wherein the LED open comparator of the failure detection circuit of the corresponding channel has a reference voltage of V_threshold_open, wherein the LED open comparator compares the V_anode with V_threshold_open, wherein the LED short comparator has reference voltage of V_threshold_short, wherein the LED short comparator compares the V_anode with V_threshold_short.

15. The method of claim 12, wherein an output signal from the LED open comparator and an output from the LED short comparator are inputted into the open latch and the short latch respectively.

16. The method of claim 12, wherein if V_anode is lower than V_threshold_short, the LED is considered shorted.

17. The method of claim 12, wherein if V_anode is larger than V_threshold_open, the LED is considered open.

18. The method of claim 12, wherein an output of the open latch and an output of the short latch are transmitted into the digital controller for PWM signal generation.

19. The method of claim 12, wherein a PWM signal to a shorted or open LED is switched off.

20. The method of claim 12, wherein a PWM signal to a redundant LED in the same pixel of the shorted or open LED is switched on.
